(19) United States
(12) Patent Application Publication
(10) Pub. No.: US 2025/0190244 A1
(43) Pub. Date: Jun. 12, 2025

(54) METHOD, APPARATUS, ELECTRONIC DEVICE AND STORAGE MEDIUM FOR DETERMINING FUNCTION TIME CONSUMPTION

(71) Applicant: Beijing Zitiao Network Technology Co., Ltd., Beijing (CN)

(72) Inventors: Guangkun JIANG, Beijing (CN); Dongping CAO, Beijing (CN)

(21) Appl. No.: 18/970,866

(22) Filed: Dec. 5, 2024

(30) Foreign Application Priority Data
Dec. 6, 2023 (CN) 202311667670.4

(51) Int. Cl. G06F 9/48

(52) U.S. Cl. CPC G06F 9/485; G06F 2209/5017

(57) ABSTRACT

Embodiments of the present disclosure provide a method, apparatus, electronic device and storage medium for determining function time consumption. The method comprises: obtaining function time consumption stacks reported by a client for a target scenario, wherein the function time consumption stacks comprise function call information and original time consumption information of at least part of functions under the target scenario; splitting each of the function time consumption stacks into a plurality of sub-stacks based on scenario stages of the target scenario; and aggregating the sub-stacks to obtain target time consumption information of the at least part of functions.

### CROSS-REFERENCE TO RELATED APPLICATION

This application claims priority to Chinese Application No. 202311667670.4 filed on Dec. 6, 2023, the disclosure of which is incorporated herein by reference in its entirety.

### FIELD

Embodiments of the present disclosure relate to the field of computer technology, and in particular, to a method, apparatus, electronic device and storage medium for determining function time consumption.

### BACKGROUND

At present, when optimizing the performance of an application program, it is often necessary to collect function time consumption on the client side to assist in performance analysis.

In testing scenarios, since the data amount is small function time consumption stacks can be analyzed individually. However, in practical application scenarios, there is involved hundreds of millions of function information reported by large-scale clients. Therefore, a method is needed to extract desired information from the massive level of function information for performance analysis.

### SUMMARY

Embodiments of the present disclosure provide a method, apparatus, electronic device and storage medium for determining function time consumption.

In a first aspect, an embodiment of the present disclosure provides a method for determining function time consumption, comprising:
obtaining function time consumption stacks reported by a client for a target scenario, wherein the function time consumption stacks comprise function call information and original time consumption information of at least part of functions under the target scenario;
splitting each of the function time consumption stacks into a plurality of sub-stacks based on scenario stages of the target scenario; and
aggregating the sub-stacks to obtain target time consumption information of the at least part of functions.

In a second aspect, an embodiment of the present disclosure further provides an apparatus for determining function time consumption, comprising:
a stack obtaining module configured to obtain function time consumption stacks reported by a client for a target scenario, wherein the function time consumption stacks comprise function call information and original time consumption information of at least part of functions under the target scenario;
a stack splitting module configured to split each of the function time consumption stacks into a plurality of sub-stacks based on scenario stages of the target scenario; and
a stack aggregating module configured to aggregate the sub-stacks to obtain target time consumption information of the at least part of functions.

In a third aspect, an embodiment of the present disclosure further provides an electronic device, comprising:
one or more processors;
a memory configured to store one or more programs,
wherein the one or more programs, when executed by the one or more processors, cause the one or more processors to implement a method for determining function time consumption as described by the embodiments of the present disclosure.

In a fourth aspect, an embodiment of the present disclosure further provides a computer readable storage medium storing a computer program thereon, the program, when executed by a processor, implementing a method for determining function time consumption as described by the embodiments of the present disclosure.

According to the method, apparatus, electronic device and storage medium for determining function time consumption provided by the embodiments of the present disclosure, function time consumption stacks reported by a client for a target scenario are obtained, wherein the function time consumption stacks comprise function call information and original time consumption information of at least part of functions under the target scenario; each of the function time consumption stacks is split into a plurality of sub-stacks based on scenario stages of the target scenario; and the sub-stacks are aggregated to obtain target time consumption information of the at least part of functions.

### BRIEF DESCRIPTION OF THE DRAWINGS

Through the more detailed description of detailed implementations with reference to the accompanying drawings, the above and other features, advantages and aspects of respective embodiments of the present disclosure will become more apparent. The same or similar reference numerals represent the same or similar elements throughout the figures. It should be understood that the figures are merely schematic, and components and elements are not necessarily drawn scale.

FIG. 1 illustrates a schematic flowchart of a method for determining function time consumption provided by embodiments of the present disclosure;

FIG. 2 illustrates a schematic flowchart of another method for determining function time consumption provided by embodiments of the present disclosure;

FIG. 3 illustrates a schematic diagram of a way of dividing a scenario stage provided by embodiments of the present disclosure;

FIG. 4a illustrates a schematic diagram of a way of merging function call trees provided by embodiments of the present disclosure;

FIG. 4b illustrates a schematic diagram of another way of merging function call trees provided by embodiments of the present disclosure;

FIG. 5 illustrates a structural block diagram of an apparatus for determining function time consumption provided by embodiments of the present disclosure; and

FIG. 6 illustrates a structural schematic diagram of an electronic device provided by embodiments of the present disclosure.

### DETAILED DESCRIPTION OF EMBODIMENTS

The embodiments of the present disclosure will be described in more detail with reference to the accompanying drawings, in which some embodiments of the present disclosure have been illustrated. However, it should be understood that the present disclosure can be implemented in various manners, and thus should not be construed to be limited to embodiments disclosed herein. On the contrary, those embodiments are provided for the thorough and complete understanding of the present disclosure. It should be understood that the drawings and embodiments of the present disclosure are only used for illustration, rather than limiting the protection scope of the present disclosure.

It should be understood that various steps described in method implementations of the present disclosure may be performed in a different order and/or in parallel. In addition, the method implementations may comprise an additional step and/or omit a step which is shown. The scope of the present disclosure is not limited in this regard.

The term “comprise” and its variants used herein are to be read as open terms that mean “include, but is not limited to.” The term “based on” is to be read as “based at least in part on.” The term “one embodiment” are to be read as “at least one embodiment.” The term “another embodiment” is to be read as “at least one other embodiment.” The term “some embodiments” are to be read as “at least some embodiments.” Other definitions will be presented in the description below.

Note that the concepts “first,” “second” and so on mentioned in the present disclosure are only for differentiating different apparatuses, modules or units rather than limiting the order or mutual dependency of functions performed by these apparatuses, modules or units.

Note that the modifications “one” and “a plurality” mentioned in the present disclosure are illustrative rather than limiting, and those skilled in the art should understand that unless otherwise specified, they should be understood as “one or more.”

Names of messages or information interacted between a plurality of apparatuses in the implementations of the present disclosure are merely for the illustration purpose, rather than limiting the scope of these messages or information.

It is to be understood that, before applying the technical solutions disclosed in various embodiments of the present disclosure, the user should be informed of the type, scope of use, and use scenario of the personal information involved in the present disclosure in an appropriate manner in accordance with relevant laws and regulations, and user authorization should be obtained.

For example, in response to receiving an active request from the user, prompt information is sent to the user to explicitly inform the user that the requested operation would acquire and use the user's personal information. Therefore, according to the prompt information, the user may decide on his/her own whether to provide the personal information to the software or hardware, such as electronic devices, applications, servers, or storage media that perform operations of the technical solutions of the present disclosure.

As an optional but non-limiting implementation, in response to receiving an active request from the user, the way of sending the prompt information to the user may, for example, include a pop-up window, and the prompt information may be presented in the form of text in the pop-up window. In addition, the pop-up window may also carry a select control for the user to choose to “agree” or “disagree” to provide the personal information to the electronic device.

It is to be understood that the above process of notifying and obtaining the user authorization is only illustrative and does not limit the implementations of the present disclosure. Other methods that satisfy relevant laws and regulations are also applicable to the implementations of the present disclosure.

Meanwhile, it is to be understood that data involved in the present technical solution (including but not limited to the data itself, the acquisition or use of the data) should comply with requirements of corresponding laws and regulations and relevant rules.

In testing scenarios, since the data amount is small function time consumption stacks can be analyzed individually. However, in practical application scenarios, there is involved hundreds of millions of function information reported by large-scale clients. Therefore, a method is needed to extract desired information from the massive level of function information for performance analysis

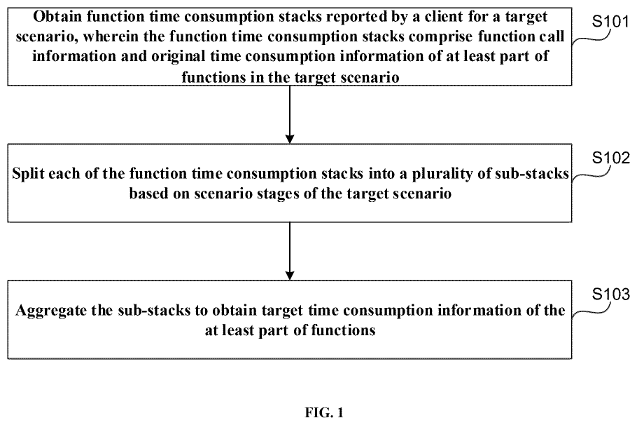

FIG. 1 is a schematic flowchart of a method for determining function time consumption provided by an embodiment of the present disclosure. The method may be performed by an apparatus for determining function time consumption, wherein the apparatus may be implemented by software and/or hardware, and may be configured in an electronic device, typically in a computer device, e.g., a data warehouse. The method for determining function time consumption provided by the embodiments of the present disclosure is applicable to a scenario in which function time consumption is determined based on function information reported by different clients, especially to a scenario in which function time consumption is determined based on stacks reported by large-scale clients. As shown in FIG. 1, the method for determining function time consumption provided by the present embodiment may comprise:

S101, obtaining function time consumption stacks reported by a client for a target scenario, wherein the function time consumption stacks comprise function call information and original time consumption information of at least part of functions under the target scenario.

The target scenario may be understood as a scenario in which function time consumption of at least part of functions needs to be determined currently, which may be any scenario during the running process of the client, such as a cold start scenario of the client and so on. The function time consumption stacks may be understood as function information related to the determining of function time consumption, which is reported in the form of stacks. The function time consumption stacks may comprise function call information and original time consumption information of at least part of functions under the target scenario. Optionally, the function time consumption stacks further comprise a marker function, the marker function being used for indicating a starting time and/or an ending time of a scenario stage corresponding to the marker function.

The at least part of functions in the target scenario may be understood as functions in the target scenario for which time consumption information needs to be determined. The at least part of functions may be set as needed, e.g., may comprise part of functions (e.g., key functions) in the target scenario, or may comprise all of functions in the target scenario. The function call information may be information which is used for describing a call relationship between the at least part of functions in the target scenario. The original function time consumption information may be time consumption information of the at least part of functions in the target scenario originally reported in the function time consumption stacks, which may be used for describing the time consumption of the at least part of functions in the target scenario, such as time consumption duration and so on.

The marker function may be used for marking different scenario stages in the target scenario, for example, the marker function may be used for indicating a starting time and/or an ending time of a scenario stage corresponding to the marker function. As an example, the client can insert marker functions at the starting and/or ending time of each scenario stage of the target scenario by means of aspect-oriented programming (AOP), indicate the start of the scenario stage through a marker function at the starting time, and/or indicate the end of the scenario stage through a marker function at the ending time, and report in function-collected stacks (i.e., function time consumption stacks). Thus, the function time consumption stacks reported by the client may carry marker functions used for indicating a starting time and/or an ending time of each scenario stage in the target scenario.

In this embodiment, when time consumption information of functions in a certain scenario (i.e., target scenario) needs to be determined, function time consumption stacks reported by different clients for the scenario may be obtained.

For example, each time entering the target scenario, the client may collect function call information and original time consumption information of at least part of functions in the target scenario, and in addition, insert marker functions at the starting time and ending time of each scenario stage, and add the function call information and the original time consumption information of the at least part of functions as well as the inserted marker functions to function time consumption stacks and report them. Accordingly, the data warehouse may receive and store function time consumption stacks reported by different clients, and obtain function time consumption stacks reported by different clients for the target scenario when time consumption information of functions in the target scenario needs to be determined.

S102, splitting each of the function time consumption stacks into a plurality of sub-stacks based on scenario stages of the target scenario.

In this embodiment, the target scenario may comprise a plurality of scenario stages. Thus, after function time consumption stacks reported by different clients for the target scenario are obtained, for each of the function time consumption stacks, the function time consumption stack may be split into a plurality of sub-stacks based on scenario stages of the target scenario. For example, sub-stacks corresponding to respective scenario stages of the target scenario may be obtained based on the starting and ending time of each scenario stage in the target scenario, so as to facilitate the aggregation of the resulting sub-stacks of different function time consumption stacks under different dimensions as needed.

S103, aggregating the sub-stacks to obtain target time consumption information of the at least part of functions.

The target time consumption information of a given function may be understood as time consumption information of the function which is determined based on function time consumption stacks reported by different clients for the target scenario.

Specifically, after each function time consumption stack is split into a plurality of sub-stacks, first, sub-stacks in different function time consumption stacks may be aggregated as needed, for example, sub-stacks corresponding to the same scenario stage may be aggregated based on the scenario stage, and/or sub-stacks corresponding to the same thread may be aggregated based on the thread, etc. Then, target time consumption information of the at least part of functions in the target scenario is determined based on a stack resulting from the aggregation, for example, time consumption information of the at least part of functions at different scenario stages and/or in different threads is determined respectively, etc. Here it is not intended to limit the processing manner of aggregating sub-stacks.

According to the method for determining function time consumption provided by this embodiment of the present disclosure, function time consumption stacks reported by a client for a target scenario are obtained, wherein the function time consumption stacks comprise function call information and original time consumption information of at least part of functions under the target scenario; each of the function time consumption stacks is split into a plurality of sub-stacks based on scenario stages of the target scenario; and the sub-stacks are aggregated to obtain target time consumption information of the at least part of functions. With the foregoing technical solution, this embodiment splits each function time consumption stack in a target scenario into sub-stacks corresponding to scenario stages of the target scenario, and aggregates the sub-stacks resulting from the splitting to obtain time consumption information of functions in the target scenario. In this way, a method for extracting information is provided which is applicable to an online scenario. The method can determine function time consumption based on a large amount of function information reported by different clients and reduce the time spent on determining function time consumption.

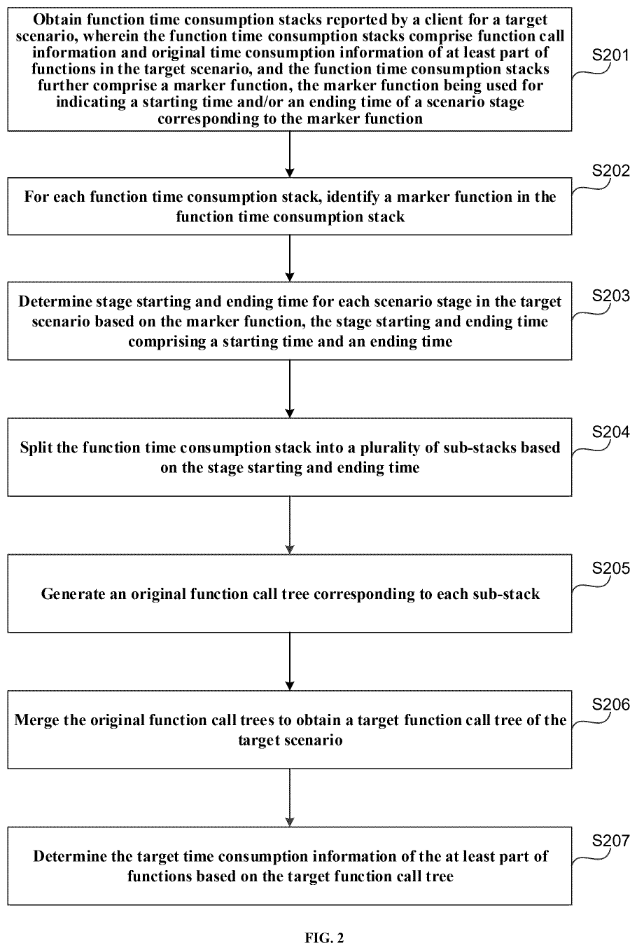

FIG. 2 is a schematic flowchart of another method for determining function time consumption provided by an embodiment of the present disclosure. The solution in this embodiment may be combined with one or more optional solutions in the foregoing embodiment. Optionally, splitting each of the function time consumption stacks into a plurality of sub-stacks based on scenario stages of the target scenario comprises: for each function time consumption stack, identifying a marker function in the function time consumption stack; determining stage starting and ending time for each scenario stage in the target scenario based on the marker function, the stage starting and ending time comprising a starting time and an ending time; and splitting the function time consumption stack into a plurality of sub-stacks based on the stage starting and ending time.

Optionally, aggregating the sub-stacks to obtain target time consumption information of the at least part of functions comprises: generating an original function call tree corresponding to each sub-stack; merging the original function call trees to obtain a target function call tree of the target scenario; and determining the target time consumption information of the at least part of functions based on the target function call tree.

Accordingly, as shown in FIG. 2, the method for determining function time consumption provided by this embodiment may comprise:

S201, obtaining function time consumption stacks reported by a client for a target scenario, wherein the function time consumption stacks comprise function call information and original time consumption information of at least part of functions under the target scenario, and the function time consumption stacks further comprise a marker function, the marker function being used for indicating a starting time and/or an ending time of a scenario stage corresponding to the marker function.

S202, for each function time consumption stack, identifying a marker function in the function time consumption stack.

In this embodiment, since the client has reported, in a function time consumption stack, a marker function corresponding to each scenario stage and used for indicating a starting time and/or an ending time of a corresponding scenario stage, when splitting a certain function time consumption stack into sub-stacks, first of all, a marker function in the function time consumption stack may be identified, for example, a marker function in the function time consumption stack is identified based on a function name and/or a function type identifier of the marker function.

S203, determining stage starting and ending time for each scenario stage in the target scenario based on the marker function, the stage starting and ending time comprising a starting time and an ending time.

The stage starting and ending time may be understood as starting and ending time of a scenario stage, or in other words, a starting time and an ending time of a scenario stage.

In this embodiment, after the marker function in the function time consumption stack is identified, stage starting and ending time of each scenario stage in the target scenario may be determined based on the marker function in the function time consumption stack.

As an example, the marker function may carry a stage identifier of a corresponding scenario stage, e.g., carry a scenario number of the corresponding scenario stage. Thus, after marker functions in the function time consumption stack are identified, for each scenario stage in the target scenario, a marker function corresponding to the scenario stage may be determined among the respective marker functions based on stage identifiers of the respective marker functions (including a marker function for indicating a starting time of the scenario stage and a marker function for indicating an ending time of the scenario stage), and determine a time indicated by the marker function for indicating the starting time of the scenario stage as the starting time of the scenario stage, and determine a time indicated by the marker function for indicating the ending time of the scenario stage as the ending time of the scenario stage.

Or the respective marker functions may be ranked according to their positions in the function time consumption stack or the order of times indicated by the respective marker functions; a marker function for indicating a starting time and a marker function for indicating an ending time which are adjacent to each other in the ranking may be determined as the marker functions for indicating the same scenario stage, and thus scenario stages of the target scenario are obtained. Moreover, in the adjacent marker functions, the time indicated by the maker function for indicating the starting time is determined as the starting time of the corresponding scenario stage, and the time indicated by the marker function for indicating the ending time is determined as the ending time of the corresponding scenario stage.

In some implementations, determining the stage starting and ending time for each scenario stage in the target scenario based on the marker function comprises: for each scenario stage, obtaining original starting and ending time indicated by a marker function corresponding to a current scenario stage; in the event that the current scenario stage calls one thread, using the original starting and ending time as stage starting and ending time of the current scenario stage; in the event that the current scenario stage calls a plurality of threads, performing stage mapping on each target thread based on the original starting and ending time to obtain a new scenario stage on each target thread, and obtaining stage starting and ending time of the new scenario stage, the target thread being a thread being called at the current scenario stage.

The new scenario stage may be understood as a virtual stage resulting from a mapping, and after the mapping is completed, the virtual stage may be used as a new scenario stage in the target scenario for subsequent aggregation. The virtual stage and an original scenario stage prior to the mapping may have the same or different starting and ending time, and/or have the same or different stage identifiers. The virtual stage with the same stage identifier may be used as the same scenario stage in the target scenario for subsequent aggregation, and the virtual stage with a different stage identifier may be used as a different scenario stage in the target scenario for subsequent aggregation. The original starting and ending time of a given scenario stage may be understood as starting and ending time (e.g., a starting time and an ending time) of the scenario stage which is indicated by a marker function corresponding to the scenario stage. The target thread of a given scenario stage may be understood as a thread called at the scenario stage, e.g., a thread used for implementing the scenario stage.

In the foregoing implementation, scenario stages may be divided for each thread in the target scenario separately. In other words, scenario stages on each thread and the starting and ending time of the scenario stage on each thread may be determined using the thread as the object for dividing scenario stages, so as to subsequently facilitate splitting and aggregation of sub-stacks as needed.

As an example, for each scenario stage in the target scenario, original starting and ending time indicated by a marker function corresponding to a current scenario stage may be obtained.

If the current scenario stage calls one thread, in other words, the current scenario stage is executed on one thread, the original starting and ending time of the current scenario stage may be determined as stage starting and ending time of the scenario stage; and/or

If the current scenario stage involves a plurality of threads, in other words, the current scenario stage is executed through at least two threads, stage mapping may be performed on each target thread at the current scenario stage based on the original starting and ending time of the current scenario stage to obtain a new scenario stage on each target thread. As an example, the current scenario stage may be mapped to a plurality of virtual stages based on the original starting and ending time of the current scenario stage. For example, the current scenario stage is mapped to each target thread corresponding to the current scenario stage to obtain virtual stages on each target thread which correspond to the current scenario stage, and each of the virtual stages may be used as a new scenario stage in the target scenario, and the current scenario stage prior to the mapping is replaced with the new scenario stage. After new scenario stages of the target scenario are obtained, stage starting and ending time of each of the new scenario stages may be obtained, so as to subsequently facilitate the splitting of sub-stacks based on the stage starting and ending time.

In the foregoing implementation, the virtual stage resulting from the mapping may or may not overlap with an original scenario stage on a corresponding thread. Optionally, the virtual stage resulting from the mapping may not overlap with an original scenario stage on a corresponding thread, i.e., the current scenario stage may be mapped to a virtual scenario stage which does not overlap with an original scenario stage on a corresponding thread, so as to facilitate the dividing of the thread into stages.

At this point, optionally, performing stage mapping on each target thread based on the original starting and ending time to obtain a new scenario stage on each target thread comprises: for each target thread, performing stage mapping on the current scenario stage on the target thread based on the original starting and ending time, so as to obtain a mapping stage on the target thread; in the event that the mapping stage overlaps with a non-mapping stage on the target thread, obtaining a stage segment of the mapping stage which does not overlap with the non-mapping stage as a new scenario stage on the target thread; and in the event that the mapping stage does not overlap with a non-mapping stage on the target thread, using the mapping stage as a new scenario stage on the target thread.

The mapping stage may be a scenario stage obtained through mapping, and stage starting and ending time of the mapping stage may be the original starting and ending time of the current scenario stage. The non-mapping scenario stage may be a scenario stage which is originally divided on the thread, other than a scenario stage obtained through mapping. The stage segment of the mapping stage may be understood a certain segment in the mapping stage, e.g., a sub-stage of the mapping stage.

As an example, for each target thread, performing stage mapping on the current scenario stage may be mapped to the target thread based on the original starting and ending time of the current scenario stage, so as to obtain a mapping stage on the target thread. It is judged, based on the stage starting and ending time of the mapping stage and the starting and ending time of a non-mapping stage on the target thread, whether the mapping stage overlaps with the non-mapping stage on the target thread in terms of time. If yes, based on the stage starting and ending time of the mapping stage and the starting and ending time of the non-mapping stage on the target thread, a stage segment of the mapping stage which does not overlap with the non-mapping stage on the target thread is obtained as a new scenario stage on the target thread obtained through mapping; if not, the mapping segment may be determined as a new scenario stage obtained through mapping on the target thread.

S204, splitting the function time consumption stack into a plurality of sub-stacks based on the stage starting and ending time.

Specifically, after obtaining starting and ending time of respective scenario stages (e.g., including a scenario stage which does not need to be mapped and a new scenario stage obtained through mapping) in the target scenario, the function time consumption stack may be split based on the starting and ending time of the respective scenario stages, for example, the function time consumption stack may be split into a plurality of sub-stacks by using the starting time and/or ending time of the respective scenario stage as a time point of the splitting.

In some implementations, considering that there might exist cross-stage functions in the function time consumption stack, e.g., there might exist functions which go through multiple scenario stages during runtime, prior to and/or during splitting the function time consumption stack, the cross-stage function may be split into a plurality of new functions according to scenario stages, and functions which are not split are replaced with the plurality of new functions resulting from the splitting, i.e., each new function resulting from the splitting is used as a function in the function time consumption stack for subsequent processing.

At this point, optionally, prior to splitting the function time consumption stack into a plurality of sub-stacks based on the stage starting and ending times, the method further comprises: for a target function starting and ending at different scenario stages, splitting the target function based on stage starting and ending time of a target scenario stage to obtain a new function corresponding to each target scenario stage, wherein the target scenario stage is a scenario stage starting and/or ending in the running process of the target function.

The target function may be understood as a cross-stage function involved in the target scenario. The target scenario stage may be understood as a scenario stage which the target function spans, e.g., a scenario stage which the target function goes through during runtime. The new function may be understood as a function obtained by splitting the target function. The new function and the target function may have the same or different function identifiers, new functions at different target scenario stages which are obtained from splitting the same target function may have the same or different function identifiers, which is not limited in this embodiment. Optionally, the new function and the target function may have the same function identifier; in other words, the new function may be considered as a target function for subsequent processing.

It is not intended to limit the manner of splitting the target function. For example, when splitting a target function, the target function may be split into a plurality of new functions, and time consumption information (e.g., function time consumption information and/or processor time consumption information) corresponding to the target function may be split based on a runtime of the target function at each target scenario stage, as time consumption information of a new function obtained from splitting at the corresponding target scenario stage.

In some implementations, when obtaining the stage starting and ending time of each scenario stage, processor starting and ending time of each scenario stage may further be obtained, for example, the client may report time consumption information of the processor (e.g., central processor, etc.) in or additionally outside the function time consumption stack. Thus, the processor starting and ending time of each scenario stage may be obtained based on matching the processor time consumption information, i.e., the processor starting time and the processor ending time corresponding to each scenario stage may be determined. At this point, optionally, prior to splitting the function time consumption stack into a plurality of sub-stacks based on the stage starting and ending times, the method further comprises determining processor starting and ending time of each scenario stage based on processor time consumption information of each scenario stage.

In some implementations, when obtaining the stage starting and ending time of each scenario stage, stage information may further be verified. As an example, the quality of stage information may be verified. For example, a stage order and/or a count of marking of the stage marker function may be verified, and the stage information which is abnormal may be marked by an abnormal code, wherein stage information with different anomalies may be marked using different abnormal codes so as to facilitate data quality management and problem identification. At this point, optionally, prior to splitting the function time consumption stack into a plurality of sub-stacks based on the stage starting and ending times, the method further comprises: verifying stage information of each scenario stage and marking the stage information which is verified as an anomaly, the stage information comprising a stage order and/or a count of marking of the marker function.

S205, generating an original function call tree corresponding to each sub-stack.

In this embodiment, after splitting the function time consumption stack into a plurality of sub-stacks, e.g., after splitting each function time consumption stack reported by different clients into a plurality of sub-stacks, an original function call tree corresponding to each sub-stack may be generated. For example, each sub-stack is represented using a tree call based on a call relationship between functions in each sub-stack, i.e., each sub-stack is converted to a multiway tree structure.

The original function call tree may be understood as a function call tree generated based on a sub-stack, and the function call tree may be used for describing a call relationship between functions involved in the corresponding sub-stack. For example, each node in the function call tree may be used for characterizing a function in the sub-stack, and a child node of a certain node in the function call tree may be used for characterizing that a function corresponding to the node calls a function corresponding to the child node. It may be understood that one sub-stack may be converted to one or more original function call trees, depending on the call relationship between functions in the sub-stack.

S206, merging the original function call trees to obtain a target function call tree of the target scenario.

In this embodiment, after obtaining original function call trees corresponding to respective sub-stacks, the respective original function call trees may be merged based on a preset merging approach, so as to obtain a target function call tree of the target scenario.

The target function call tree may be understood as a function call tree obtained from merging the original function call trees corresponding to sub-stacks in different function time consumption stacks. The quantity of obtained target function call trees may one or more, and different target function call trees may constitute a target function call forest of the target scenario. The preset merging approach may be used for indicating a merging order of the original function call trees, and may be set as needed. For example, the preset merging approach may be set as merging in stages and in threads based on a divide-and-conquer idea.

In some implementations, merging the original function call trees to obtain the target function call tree of the target scenario comprises: for each scenario stage of each thread, merging original function call trees corresponding to the scenario stage at the function time consumption stacks to obtain a first function call tree corresponding to the scenario stage; for each thread, merging the first function call trees corresponding to different scenario stages in the thread to obtain a second function call tree corresponding to the thread; and merging the second function call trees corresponding to different threads to obtain the target function call tree of the target scenario.

The first function call tree may be a function call tree corresponding to a scenario stage in a thread, which may be obtained by merging original function call trees corresponding to the scenario stage in the thread in different function time consumption stacks, and the first function call tree aggregates function call information and function time consumption information from different function time consumption stacks which is related to the corresponding scenario stage in the corresponding thread corresponding to the first function call tree. The second function call tree may be a function call tree obtained by merging the first function call trees corresponding to different scenario stages in the same thread, which may correspond to a thread. The same thread or not may be determined depending on whether the thread identifiers are the same. For example, if thread identifiers of certain threads in different function time consumption stacks are the same, then the corresponding threads in different function time consumption stacks may be determined as the same thread.

As an example, first of all, original function call trees corresponding to the same scenario stage in the same thread in different function time consumption stacks may be merged based on threads and scenario stages, to obtain a first function call tree corresponding to each scenario stage in each thread. Then, the first function call trees corresponding to different scenario stages in the same thread are merged based on threads, to obtain a second function call tree corresponding to each thread. Finally, the second function call trees in different threads in the target scenario are merged to obtain a target function call tree corresponding to the target scenario.

In the foregoing implementation, when merging original function call trees corresponding to different function time consumption stacks, the respective original function call trees may be directly merged without considering whether the function time consumption stacks corresponding to the original function call trees are the same or not.

In the foregoing implementation, when merging original function call trees corresponding to different function time consumption stacks, it is also possible to consider whether the function time consumption stacks corresponding to the respective original function call trees are the same. Stack self-aggregation is performed first, and then inter-stack aggregation is performed. For example, for each function time consumption stack, first, original function call trees corresponding to the scenario stage of the thread in the function time consumption stack are merged to obtain a third function call tree corresponding to the scenario stage of the thread in the function time consumption stack. Then, the third function call trees corresponding to the scenario stage of the thread in different function time consumption stacks are merged to obtain the first function call tree corresponding to the scenario stage of the thread. The third function call tree may be a function call tree obtained by merging original function call trees corresponding to a certain scenario stage of a certain thread in a single function time consumption stack.

At this point, optionally, merging original function call trees corresponding to the scenario stage at the function time consumption stacks to obtain the first function call tree corresponding to the scenario stage comprises: merging original function call trees corresponding to the scenario stage in each function time consumption stack, respectively, so as to obtain a third function call tree corresponding to the scenario stage in each function time consumption stack; and merging the third function call trees corresponding to the scenario stage in different function time consumption stacks to obtain the first function call tree corresponding to the scenario stage.

In this embodiment, to facilitate cross-stack thread merging, in other words, to merge threads involved in function time consumption stacks reported by different clients, prior to merging sub-stacks of different function time consumption stacks, a thread identifier involved in the target scenario may further be converted, for example, threads involved in function time consumption stacks reported by different clients may be identified in a uniform way. At this point, optionally, threads with the same thread identifier are the same thread, and prior to aggregating the sub-stacks, the method further comprises: adjusting a thread identifier of a thread called in the target scenario. It is not intended to limit the way of adjusting the thread identifier, so long as threads involved in function time consumption stacks reported by different clients can be identified in a uniform way.

In some implementations, adjusting the thread identifier of the thread called in the target scenario comprises at least one of: adjusting a thread identifier of a first thread in the target scenario as a first preset thread identifier, the first thread being a main thread; adjusting a thread identifier of a second thread in the target scenario as a thread identifier associated with the second thread, the second thread being a sub thread called at a scenario stage of the target scenario; and adjusting a thread identifier of a third thread in the target scenario as a second preset thread identifier, the third thread being a sub thread other than the second thread in the target scenario.

The first preset thread identifier and the second preset thread identifier may be different thread identifiers which are set in advance. For example, the first preset thread identifier may be set as 1, and the second preset thread identifier may be set as 2, 9 or 999, etc. The thread identifier associated with the second thread may be a thread identifier generated based on information related to the second thread, for example, the thread identifier of the second thread may be generated based on a stage number of a scenario stage corresponding to the second thread and a value of a preset order field in the scenario stage corresponding to the second thread. Different second threads may have different thread identifiers.

In the foregoing implementation, the thread identifier of each thread in the target scenario may be adjusted based on a type of the thread and/or the degree of association of the thread with the thread stage in the target scenario.

As an example, the thread identifier of a main thread (i.e., first thread) in the target scenario may be adjusted as the first preset thread identifier, the thread identifier of a sub thread (i.e., second thread) related to a scenario stage in the target scenario may be adjusted as a thread identifier associated with a scenario stage corresponding to the thread, and the thread identifier of a sub thread (i.e., third thread) irrelevant to a scenario stage in the target scenario may be adjusted as the third preset thread identifier. At this point, different third threads may have the same thread identifier, i.e., the third preset thread identifier.

S207, determining the target time consumption information of the at least part of functions based on the target function call tree.

In this embodiment, the target function call tree aggregates information in function time consumption stacks reported by different clients, and after obtaining the target function call tree, target time consumption information of one or more functions in the target scenario may be determined based on the target function call tree.

In addition, some aggregation metrics may further be calculated based on the target function call tree, e.g., calculating the quartile and average of the function time consumption as well as the penetration of the function, etc., which may be set as needed.

In some implementations, a visualization file of the target scenario may be generated based on the target function call tree, so as to subsequently present the time consumption information of the at least part of functions in the target scenario to related personnel in a visual way by running the visualization file. At this point, optionally, determining the target time consumption information of the at least part of functions based on the target function call tree comprises: generating a function time consumption file of the target scenario based on the target function call tree, the function time consumption file being a visualization file, the visualization file being used for presenting target time consumption information of each function in the at least part of functions. The function time consumption file may be a file for describing the function time consumption in the target scenario. The function time consumption file may be a visualization file, while a file type of the visualization file is not limited. As an example, the visualization file may be a perfetto protobuf file.

In this embodiment, to further reduce the size of the target function call tree, the target function call tree may be pruned. For example, a function node in the target function call tree in which parameter value is a default value may be pruned, so as to reduce the amount of calculation involved in subsequently determining the target function time consumption information based on the target function call tree. At this point, prior to determining the target time consumption information of the at least part of functions based on the target function call tree, the method further comprises: pruning a function node in the target function call tree in which parameter value is a default value.

The method for determining function time consumption provided by this embodiment can further reduce the time spent on determining function time consumption and increase the accuracy of the result of determining function time consumption on the premise of determining function time consumption based on a large amount of function information reported by different clients.

In some optional implementations, the method for determining function time consumption provided by the embodiments of the present disclosure may be mainly divided into two parts:

The first part: stage splitting (i.e., splitting each of the function time consumption stacks into a plurality of sub-stacks based on scenario stages of the target scenario). The client collects functions to report based on the scenario, and in order to facilitate the analysis, each scenario is divided into a plurality of stages which are differentiated by specific marker functions, and each function is assigned to a unique stage. For metrics precision, a cross-stage function is segmented by stage; a cross-thread stage is reflected in each thread by mapping.

The second part: aggregating functions reported by respective clients (i.e., aggregating the sub-stacks to target time consumption information of the at least part of functions). In order to increase the aggregation efficiency, aggregation is performed in threads and in stages based on a divide-and-conquer idea, i.e., first single stack self-aggregation, then inter-stack aggregation, and finally merging stages and threads. In order to guarantee metrics accuracy, function information is rebuilt as a multinomial tree, and recursive merging is performed from a root node to leaf nodes with the help of the tree structure. Due to the complexity of the final merged data link, there are many nodes, each new indicator will have a greater impact on the size of the product, for some metrics which can be downsampled are downsampled, for example, not all methods have the central processing unit (Central Processing Unit, CPU) time consumption. The final output of the aggregation product is a perfetto protobuf format file, which can be presented in a visual way directly through perfetto ui.

An exemplary illustration is presented below to the method for determining function time consumption provided by the embodiments of the present disclosure based on the above two parts.

The first part: the client inserts marker functions at starting and ending time of each stage by way of AOP, which are reported in stacks where functions are collected and processed in a data warehouse. The process of the data warehouse may be divided into the following steps:

A1, collecting and verifying stage information: a starting time and an ending time of each stage are obtained through marker functions from each reported stack. Moreover, a CPU starting time and a CPU ending time of the stage are obtained by matching additionally reported CPU time consumption information. Stage information is verified (mainly including a stage order and a count of stage marker functions, etc.), and the stage information is verified by different anomaly codes so as to facilitate data quality management and problem identification. For example, stage dimension information (e.g., order and verification information) may be managed through a a record table storing stage information.

It is noteworthy that, taking a video-based client for example, the order of stages may be fixed, e.g., in a cold-start scenario, the initialiaation of the network client may be performed first followed by the initialization of the first frame. However, the number of stages is not necessarily equal, for example, a device with a cache has one fewer stage to fetch the first video (i.e., the first flush phase) at cold start than a device without a cache. In addition, marker functions for stages are not always the same, there may be a case in which the network client stage initialization fails but the retry succeeds, at which point there may be one more marker function for the start of the stage. The above order and information on the number of allowed marker functions may be stored and maintained in the above record table.

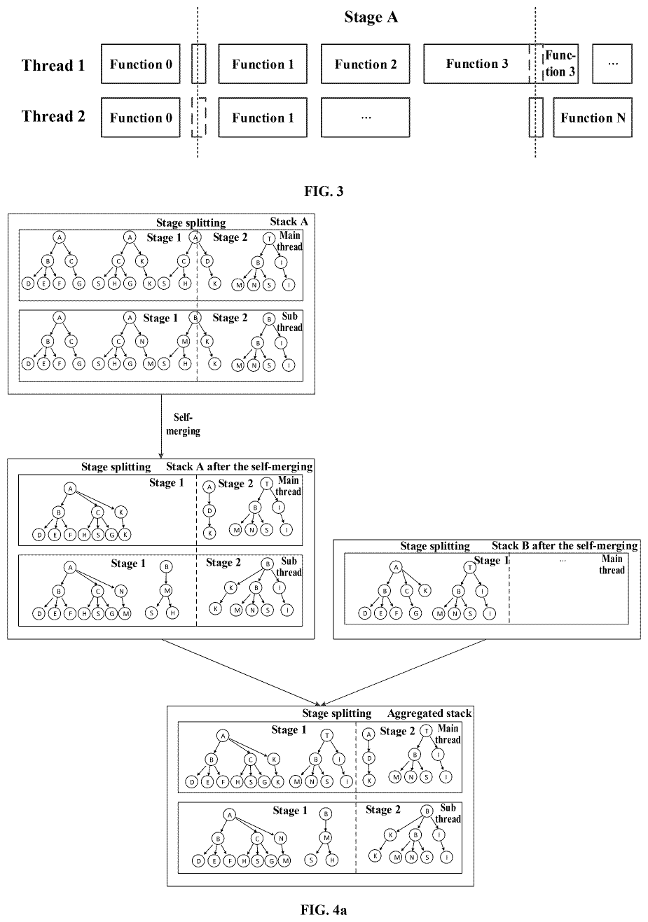

A2, splitting the collected stack into stages: splitting a function into stages based on time ranges of stages, with the splitting way as shown in FIG. 3 (two threads are taken for example).

Part of stages start from a main thread and end at a sub thread. At this point, the stage may be split into two virtual stages, and a stage out_flag field marks a stage starting thread or a stage ending thread (so as to facilitate subsequent thread marking), to facilitate the subsequent dividing of functions into stages and dividing of threads. As shown in FIG. 3, stage A starts in thread 1 and ends in thread 2, at which point virtual threads corresponding to stage A may be mapped on thread 1 and thread 2 respectively based on a starting time and an ending time of stage A.

Part of underlying functions will span stages, at which point an impact will be exerted on the accuracy of final data if such functions are all retained or discarded. Thus, such functions are segmented, one function is segmented into a plurality of functions based on time (at which point the CPU time consumption may be divided proportionally based on the time proportion of sub-functions), and divided into stages based on time intervals. As shown in FIG. 3, function 3 spans stage A and the next stage to stage A. At this point, function 3 may be split into a new function at stage A and a new function at the next stage based on elapsed times of function 3 at stage A and the next stage, and both the new functions may be treated as function 3 for subsequent processing. In addition, uniform conversion of thread unique ID (identity document) may be performed. As an example, the main thread uses 1, and other scenario-related threads (e.g., key threads) use customized special thread identifiers thread_id (obtained by using the stage number and the stage out_flagz field), and other unimportant threads uniformly use 999, so as to support subsequent merging of threads from the same stage across the stack.

The second part: distributed aggregation capability can be achieved using SPARK user defined aggregation functions (UDAF) for aggregating massive stacks, which is specifically as follows:

B1, stack aggregation: the function call is a tree call, which, as a whole, may be understood as a multinomial tree structure. The stack reported by the client at one time comprises many groups of function calls, i.e., a forest. Thus, the stack reported by the client may first be converted into a tree, and recursive traversal merging may be performed from the root node.

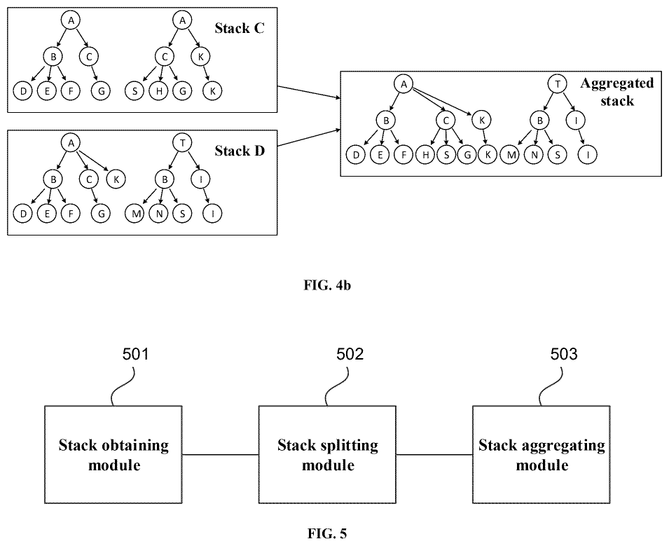

For example, after converting the stack reported by the client into a multinomial tree, stage splitting may be performed, self-merging may be performed between stages to obtain a multinomial tree after the self-merging, and the multinomial tree is subjected to inter-stack aggregation based on stages to obtain an aggregated stack, as shown in FIG. 4a. It may be understood that the aggregated stack may be further merged based on stages and threads. Or the stack reported by the client is divided into a plurality of sub-stacks, then the respective sub-stacks are converted into corresponding multinomial trees, and further the multinomial trees corresponding to the respective sub-stacks are subjected to recursive traversal merging to obtain an aggregated stack, as shown in FIG. 4b. Function information reported by one client in sequence may be built as multiple multinomial trees, wherein each node in the multinomial tree carries temporal information, and due to the temporal information, nodes are sequential. The aggregated stack may be formed by a plurality of multinomial trees (i.e., target function call trees), and each node in the multinomial tree carries aggregation aggregation metrics including, for example, average time consumption, total time consumption, count, quartile (PCT), and/or user volume (UV), etc.

Some aggregation metrics may be calculated after the merging of big data. However, the distribution information of data may be lost, and at the same time, the penetration rate may be difficult to calculate. Thus, quartiles may be introduced to record the distribution information of data. In the case of higher orders of magnitude (e.g., hundreds of millions of data), the precise quartile calculation might be impossible, so apachedatasketches can be introduced to perform an approximate quartile calculation.

B2, the product of the merging is finally converted into a perfetto protobuf file, which can be provided to client developers for analysis. In addition, since the product of the merging might comprise millions of function nodes, the product is relatively huge. Thus, the size of the final product can be reduced by judiciously pruning the metrics of some of the parameters which are default values, and by assigning null to the metrics, the metrics are ignored when the final product (i.e., perfetto protobuf file) is generated.

Finally, the generated aggregation product may be built as a perfetto protobuf file, and additionally calculated aggregation metrics may be placed into the annotation.

In this way, while supporting real application scenarios where there are a large number of clients, the stack information reported by different clients (e.g., the same or different versions of clients) is aggregated, and finally an aggregated stack is generated with a certain amount of metrics information, thereby facilitating client developers to analyse the performance of the function time consumption of clients in real application scenarios.

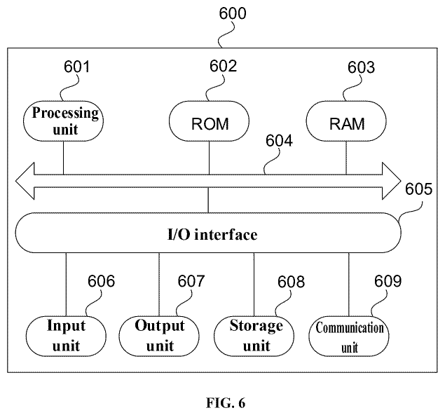

FIG. 5 is a structural block diagram of an apparatus for determining function time consumption provided by an embodiment of the present disclosure. The apparatus may be implemented by software and/or hardware, and may be configured in an electronic device, typically in a computer device, e.g., a data warehouse. The apparatus can determine function time consumption based on function information reported by different clients, e.g., determine function time consumption based on stacks reported by large-scale clients, by performing a method for determining function time consumption. As shown in FIG. 5, the apparatus for determining function time consumption provided by this embodiment may comprise: a stack obtaining module 501, a stack splitting module 502 and a stack aggregating module 503, wherein
the stack obtaining module 501 is configured to obtain function time consumption stacks reported by a client for a target scenario, wherein the function time consumption stacks comprise function call information and original time consumption information of at least part of functions under the target scenario;
the stack splitting module 502 is configured to split each of the function time consumption stacks into a plurality of sub-stacks based on scenario stages of the target scenario; and
the stack aggregating module 503 is configured to aggregate the sub-stacks to obtain target time consumption information of the at least part of functions.

According to the apparatus for determining function time consumption provided by this embodiment of the present disclosure, function time consumption stacks reported by a client for a target scenario are obtained, wherein the function time consumption stacks comprise function call information and original time consumption information of at least part of functions under the target scenario; each of the function time consumption stacks is split into a plurality of sub-stacks based on scenario stages of the target scenario; and the sub-stacks are aggregated to obtain target time consumption information of the at least part of functions. With the foregoing technical solution, this embodiment splits each function time consumption stack in a target scenario into sub-stacks corresponding to scenario stages of the target scenario, and aggregates the sub-stacks resulting from the splitting to obtain time consumption information of functions in the target scenario. In this way, a method for extracting information is provided which is applicable to an online scenario. The method can determine function time consumption based on a large amount of function information reported by different clients and reduce the time spent on determining function time consumption.

Optionally, the function time consumption stacks further comprise a marker function, the marker function being used for indicating a starting time and/or an ending time of a scenario stage corresponding to the marker function.

Optionally, the stack splitting module 502 may comprise: a function identifying unit configured to, for each function time consumption stack, identify a marker function in the function time consumption stack; a time determining unit configured to determine stage starting and ending time for each scenario stage in the target scenario based on the marker function, the stage starting and ending time comprising a starting time and an ending time; and a stack splitting unit configured to split the function time consumption stack into a plurality of sub-stacks based on the stage starting and ending time.

Optionally, the time determining unit comprises: a time obtaining sub-unit configured to, for each scenario stage, obtain original starting and ending time indicated by a marker function corresponding to a current scenario stage; a first determining sub-unit configured to, in the event that the current scenario stage calls one thread, use the original starting and ending time as stage starting and ending time of the current scenario stage; and a a second determining sub-unit configured to, in the event that the current scenario stage calls a plurality of threads, perform stage mapping on each target thread based on the original starting and ending time to obtain a new scenario stage on each target thread, and obtain stage starting and ending time of the new scenario stage, the target thread being a thread being called at the current scenario stage.

Optionally, the second determining sub-unit is configured to: for each target thread, perform stage mapping on the current scenario stage on the target thread based on the original starting and ending time, so as to obtain a mapping stage on the target thread; in the event that the mapping stage overlaps with a non-mapping stage on the target thread, obtain a stage segment of the mapping stage which does not overlap with the non-mapping stage as a new scenario stage on the target thread; and in the event that the mapping stage does not overlap with a non-mapping stage on the target thread, use the mapping stage as a new scenario stage on the target thread.

Further, the apparatus for determining function time consumption provided by this embodiment may further comprise at least one of: a function splitting module configured to, prior to splitting the function time consumption stack into a plurality of sub-stacks based on the stage starting and ending times, for a target function starting and ending at different scenario stages, split the target function based on stage starting and ending time of a target scenario stage to obtain a new function corresponding to each target scenario stage, wherein the target scenario stage is a scenario stage starting and/or ending in the running process of the target function; a time determining module configured to determine processor starting and ending time of each scenario stage based on processor time consumption information of each scenario stage; and a verifying module configured to verify stage information of each scenario stage and mark the stage information which is verified as an anomaly, the stage information comprising a stage order and/or a count of marking of the marker function.

Optionally, the stack aggregating module 503 may comprise: a call tree generating unit configured to generate an original function call tree corresponding to each sub-stack; a merging processing unit configured to merge the original function call trees to obtain a target function call tree of the target scenario; and an information determining unit configured to determine the target time consumption information of the at least part of functions based on the target function call tree.

Optionally, the merging processing unit comprises: a first merging processing sub-unit configured to, for each scenario stage of each thread, merge original function call trees corresponding to the scenario stage at the function time consumption stacks to obtain a first function call tree corresponding to the scenario stage; a second merging processing sub-unit configured to, for each thread, merge the first function call trees corresponding to different scenario stages in the thread to obtain a second function call tree corresponding to the thread; and a third merging processing sub-unit configured to merge the second function call trees corresponding to different threads to obtain the target function call tree of the target scenario.

Optionally, the first merging processing sub-unit is configured to: merge original function call trees corresponding to the scenario stage in each function time consumption stack, respectively, so as to obtain a third function call tree corresponding to the scenario stage in each function time consumption stack; and merge the third function call trees corresponding to the scenario stage in different function time consumption stacks to obtain the first function call tree corresponding to the scenario stage.

Optionally, threads with the same thread identifier are the same thread, and the apparatus for determining function time consumption provided by this embodiment may further comprise: an identifier adjusting module configured to, prior to aggregating the sub-stacks, adjust a thread identifier of a thread called in the target scenario.

Optionally, the identifier adjusting module may be configured to perform at least one of: adjusting a thread identifier of a first thread in the target scenario as a first preset thread identifier, the first thread being a main thread;
adjusting a thread identifier of a second thread in the target scenario as a thread identifier associated with the second thread, the second thread being a sub thread called at a scenario stage of the target scenario; and
adjusting a thread identifier of a third thread in the target scenario as a second preset thread identifier, the third thread being a sub thread other than the second thread in the target scenario.

Optionally, the information determining unit is configured to: generate a function time consumption file of the target scenario based on the target function call tree, the function time consumption file being a visualization file, the visualization file being used for presenting target time consumption information of each function in the at least part of functions.

Further, the apparatus for determining function time consumption provided by this embodiment may further comprise: a pruning module configured to, prior to determining the target time consumption information of the at least part of functions based on the target function call tree, prune a function node in the target function call tree in which parameter value is a default value.

The apparatus for determining function time consumption provided by the embodiment of the present disclosure can perform the method for determining function time consumption provided by any of the embodiments of the present disclosure, which includes corresponding functional modules for performing the method and has the advantageous effects. For technical details which are not detailed in this embodiment, reference may be made to the method for determining function time consumption provided by any of the embodiments of the present disclosure.

With reference to FIG. 6 below, this figure shows a structural schematic diagram of an electronic device (e.g., terminal device) 600 which is applicable to implement the embodiments of the present disclosure. The terminal device in the embodiments of the present disclosure may include, without limitation to, a mobile terminal such as a mobile phone, a notebook computer, a digital broadcast receiver, a PDA (personal digital assistant), a PAD (portable Android device), a PMP (portable multimedia player), an on-board terminal (e.g., an on-board navigation terminal) and the like, and a fixed terminal such as digital TV, a desktop computer and the like. The electronic device shown in FIG. 6 is merely an example and should not be construed as bringing any restriction on the functionality and usage scope of the embodiments of the present disclosure.

As shown in FIG. 6, the electronic device 600 may comprises a processing unit (e.g., a central

processor, a graphics processor) 601 which is capable of performing various appropriate actions and processes in accordance with programs stored in a read only memory (ROM) 602 or programs loaded from a storage unit 608 to a random access memory (RAM) 603. In the RAM 603, there are also stored various programs and data required by the electronic device 600 when operating. The processing unit 601, the ROM 602 and the RAM 603 are connected to one another via a bus 604. An input/output (I/O) interface 605 is also connected to the bus 604.

Usually, the following units may be connected to the I/O interface 605: an input unit 606 including a touch screen, a touch pad, a keyboard, a mouse, a camera, a microphone, an accelerometers, a gyroscope, or the like; an output unit 607, such as a liquid-crystal display (LCD), a loudspeaker, a vibrator, or the like; a storage unit 608, such as a a magnetic tape, a hard disk or the like; and a communication unit 609. The communication unit 609 allows the electronic device to perform wireless or wired communication with other device so as to exchange data with other device. While FIG. 6 shows the electronic device with various units, it should be understood that it is not required to implement or have all of the illustrated units. Alternatively, more or less units may be implemented or exist.

Specifically, according to the embodiments of the present disclosure, the procedures described with reference to the flowchart may be implemented as computer software programs. For example, the embodiments of the present disclosure comprise a computer program product that comprises a computer program embodied on a non-transitory computer-readable medium, the computer program including program codes for executing the method shown in the flowchart. In such an embodiment, the computer program may be loaded and installed from a network via the communication unit 609, or installed from the storage unit 608, or installed from the ROM 602. The computer program, when executed by the processing unit 601, perform the above functions defined in the method of the embodiments of the present disclosure.

It is noteworthy that the computer readable medium of the present disclosure can be a computer readable signal medium, a computer readable storage medium or any combination thereof. The computer readable storage medium may be, for example, but is not limited to, an electronic, magnetic, optical, electromagnetic, infrared or semiconductor system, apparatus or device, or any combination of the foregoing. More specific examples of the computer readable storage medium may include, without limitation to, the following: an electrical connection with one or more conductors, a portable computer diskette, a hard disk, a random access memory (RAM), a read-only memory (ROM), an erasable programmable read-only memory (EPROM or flash memory), an optical fiber, a portable compact disc read-only memory (CD-ROM), an optical storage device, a magnetic storage device, or any suitable combination of the foregoing. In the present disclosure, the computer readable storage medium may be any tangible medium containing or storing a program which may be used by an instruction executing system, apparatus or device or used in conjunction therewith. In the present disclosure, the computer readable signal medium may include a data signal propagated in baseband or as part of a carrier wave, with computer readable program code carried therein. The data signal propagated as such may take various forms, including without limitation to, an electromagnetic signal, an optical signal or any suitable combination of the foregoing. The computer readable signal medium may further be any other computer readable medium than the computer readable storage medium, which computer readable signal medium may send, propagate or transmit a program used by an instruction executing system, apparatus or device or used in conjunction with the foregoing. The program code included in the computer readable medium may be transmitted using any suitable medium, including without limitation to, an electrical wire, an optical fiber cable, RF (radio frequency), etc., or any suitable combination of the foregoing.

In some implementations, the authentication server and the background server may communicate using any network protocol that is currently known or will be developed in future, such as the hyper text transfer protocol (HTTP) and the like, and may be interconnected with digital data communication (e.g., communication network) in any form or medium. Examples of communication networks include local area networks (LANs), wide area networks (WANs), inter-networks (e.g., the Internet) and end-to-end networks (e.g., ad hoc end-to-end networks), as well as any networks that are currently known or will be developed in future.

The above computer readable medium may be included in the above-mentioned electronic device; and it may also exist alone without being assembled into the electronic device.

The computer readable medium carries one or more programs which, when executed by the electronic device, cause the electronic device to: obtain function time consumption stacks reported by a client for a target scenario, wherein the function time consumption stacks comprise function call information and original time consumption information of at least part of functions under the target scenario; split each of the function time consumption stacks into a plurality of sub-stacks based on scenario stages of the target scenario; and aggregate the sub-stacks to obtain target time consumption information of the at least part of functions.

Computer program codes for carrying out operations of the present disclosure may be written in one or more programming languages, including without limitation to, an object oriented programming language such as Java, Smalltalk, C++ or the like, and conventional procedural programming languages, such as the “C” programming language or similar programming languages. The program codes may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

The flowchart and block diagrams in the figures illustrate the architecture, functionality, and operation of possible implementations of systems, methods and computer program products according to various implementations of the present disclosure. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The units described in the embodiments of the present disclosure may be implemented as software or hardware. Wherein the name of a module does not form any limitation to the module per se.

The functions described above may be executed, at least in part, by one or more hardware logic components. For example, and without limitation, illustrative types of hardware logic components that can be used include Field-programmable Gate Arrays (FPGAs), Application-specific Integrated Circuits (ASICs), Application-specific Standard Products (ASSPs), System-on-a-chip systems (SOCs), Complex Programmable Logic Devices (CPLDs), etc.

In the context of the present disclosure, the machine readable medium may be a tangible medium, which may include or store a program used by an instruction executing system, apparatus or device or used in conjunction with the foregoing. The machine readable medium may be a machine readable signal medium or a machine readable storage medium. The machine readable medium may include, but is not limited to, an electronic, magnetic, optical, electromagnetic, infrared, semiconductor system, means or device, or any suitable combination of the foregoing. More specific examples of the machine readable storage medium include the following: an electric connection with one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing.

According to one or more embodiments of the present disclosure, a first example provides a method for determining function time consumption, comprising:
obtaining function time consumption stacks reported by a client for a target scenario, wherein the function time consumption stacks comprise function call information and original time consumption information of at least part of functions under the target scenario;
splitting each of the function time consumption stacks into a plurality of sub-stacks based on scenario stages of the target scenario; and
aggregating the sub-stacks to obtain target time consumption information of the at least part of functions.

According to one or more embodiments of the present disclosure, in a second example of the method according to the first example, the function time consumption stacks further comprise a marker function, the marker function being used for indicating a starting time and/or an ending time of a scenario stage corresponding to the marker function.

According to one or more embodiments of the present disclosure, in a third example of the method according to the second example, splitting each of the function time consumption stacks into a plurality of sub-stacks based on scenario stages of the target scenario comprises:
for each function time consumption stack, identifying a marker function in the function time consumption stack;
determining stage starting and ending time for each scenario stage in the target scenario based on the marker function, the stage starting and ending time comprising a starting time and an ending time;
splitting the function time consumption stack into a plurality of sub-stacks based on the stage starting and ending time.

According to one or more embodiments of the present disclosure, in a fourth example of the method according to the third example, determining the stage starting and ending time for each scenario stage in the target scenario based on the marker function comprises:
for each scenario stage, obtaining original starting and ending time indicated by a marker function corresponding to a current scenario stage;
in the event that the current scenario stage calls one thread, using the original starting and ending time as stage starting and ending time of the current scenario stage;
in the event that the current scenario stage calls a plurality of threads, performing stage mapping on each target thread based on the original starting and ending time to obtain a new scenario stage on each target thread, and obtaining stage starting and ending time of the new scenario stage, the target thread being a thread being called at the current scenario stage.

According to one or more embodiments of the present disclosure, in a fifth example of the method according to the fourth example, performing stage mapping on each target thread based on the original starting and ending time to obtain a new scenario stage on each target thread comprises:
for each target thread, performing stage mapping on the current scenario stage on the target thread based on the original starting and ending time, so as to obtain a mapping stage on the target thread;
in the event that the mapping stage overlaps with a non-mapping stage on the target thread, obtaining a stage segment of the mapping stage which does not overlap with the non-mapping stage as a new scenario stage on the target thread; and
in the event that the mapping stage does not overlap with a non-mapping stage on the target thread, using the mapping stage as a new scenario stage on the target thread.

According to one or more embodiments of the present disclosure, in a sixth example of the method according to the third example, prior to splitting the function time consumption stack into a plurality of sub-stacks based on the stage starting and ending times, the method further comprises at least one of:
for a target function starting and ending at different scenario stages, splitting the target function based on stage starting and ending time of a target scenario stage to obtain a new function corresponding to each target scenario stage, wherein the target scenario stage is a scenario stage starting and/or ending in the running process of the target function;
determining processor starting and ending time of each scenario stage based on processor time consumption information of each scenario stage; and
verifying stage information of each scenario stage and marking the stage information which is verified as an anomaly, the stage information comprising a stage order and/or a count of marking of the marker function.

According to one or more embodiments of the present disclosure, in a seventh example of the method according to any of the first to sixth examples, aggregating the sub-stacks to obtain target time consumption information of the at least part of functions comprises:
generating an original function call tree corresponding to each sub-stack;
merging the original function call trees to obtain a target function call tree of the target scenario; and
determining the target time consumption information of the at least part of functions based on the target function call tree.

According to one or more embodiments of the present disclosure, in an eighth example of the method according to the seventh example, merging the original function call trees to obtain the target function call tree of the target scenario comprises:
for each scenario stage of each thread, merging original function call trees corresponding to the scenario stage at the function time consumption stacks to obtain a first function call tree corresponding to the scenario stage;
for each thread, merging the first function call trees corresponding to different scenario stages in the thread to obtain a second function call tree corresponding to the thread; and
merging the second function call trees corresponding to different threads to obtain the target function call tree of the target scenario.

According to one or more embodiments of the present disclosure, in a ninth example of the method according to the eighth example, merging original function call trees corresponding to the scenario stage at the function time consumption stacks to obtain the first function call tree corresponding to the scenario stage comprises:
merging original function call trees corresponding to the scenario stage in each function time consumption stack, respectively, so as to obtain a third function call tree corresponding to the scenario stage in each function time consumption stack; and
merging the third function call trees corresponding to the scenario stage in different function time consumption stacks to obtain the first function call tree corresponding to the scenario stage.

According to one or more embodiments of the present disclosure, in a tenth example of the method according to the eighth example, threads with the same thread identifier are the same thread, and prior to aggregating the sub-stacks, the method further comprises:
adjusting a thread identifier of a thread called in the target scenario.

According to one or more embodiments of the present disclosure, in an eleventh example of the method according to the tenth example, adjusting the thread identifier of the thread called in the target scenario comprises at least one of:
adjusting a thread identifier of a first thread in the target scenario as a first preset thread identifier, the first thread being a main thread;
adjusting a thread identifier of a second thread in the target scenario as a thread identifier associated with the second thread, the second thread being a sub thread called at a scenario stage of the target scenario; and
adjusting a thread identifier of a third thread in the target scenario as a second preset thread identifier, the third thread being a sub thread other than the second thread in the target scenario.

According to one or more embodiments of the present disclosure, in a twelfth example of the method according to the seventh example, determining the target time consumption information of the at least part of functions based on the target function call tree comprises:
generating a function time consumption file of the target scenario based on the target function call tree, the function time consumption file being a visualization file, the visualization file being used for presenting target time consumption information of each function in the at least part of functions.

According to one or more embodiments of the present disclosure, in a thirteenth example of the method according to the seventh example, prior to determining the target time consumption information of the at least part of functions based on the target function call tree, the method further comprises:
pruning a function node in the target function call tree in which parameter value is a default value.

According to one or more embodiments of the present disclosure, a fourteenth example provides an apparatus for determining function time consumption, comprising:
a stack obtaining module configured to obtain function time consumption stacks reported by a client for a target scenario, wherein the function time consumption stacks comprise function call information and original time consumption information of at least part of functions under the target scenario;
a stack splitting module configured to split each of the function time consumption stacks into a plurality of sub-stacks based on scenario stages of the target scenario; and
a stack aggregating module configured to aggregate the sub-stacks to obtain target time consumption information of the at least part of functions.

According to one or more embodiments of the present disclosure, a fifteenth example provides an electronic device, comprising:
one or more processors;
a memory configured to store one or more programs,
wherein, the one or more programs, when executed by the one or more processors, cause the one or more processors to implement a method for determining function time consumption of any of the first to thirteenth examples.

According to one or more embodiments of the present disclosure, a sixteenth example provides a computer readable storage medium, wherein the computer readable storage medium stores a program thereon which, when executed by a processor, implements a method for determining function time consumption of any of the first to thirteenth examples.

The foregoing description merely illustrates the preferable embodiments of the present disclosure and used technical principles. Those skilled in the art should understand that the scope of the present disclosure is not limited to technical solutions formed by specific combinations of the foregoing technical features and also cover other technical solution formed by any combinations of the foregoing or equivalent features without departing from the concept of the present disclosure, such as a technical solution formed by replacing the foregoing features with the technical features disclosed in the present disclosure (but not limited to) with similar functions.

In addition, although various operations are depicted in a particular order, this should not be construed as requiring that these operations be performed in the particular order shown or in a sequential order. In a given environment, multitasking and parallel processing may be advantageous. Likewise, although the above discussion contains several specific implementation details, these should not be construed as limitations on the scope of the present disclosure. Certain features that are described in the context of separate embodiments can also be implemented in combination in a single embodiment. Conversely, various features that are described in the context of a single embodiment can also be implemented in multiple embodiments separately or in any suitable subcombination.

Although the subject matter has been described in language specific to structural features and/or method logical acts, it is to be understood that the subject matter defined in the appended claims is not necessarily limited to the specific features or acts described above. On the contrary, the specific features and acts described above are merely example forms of implementing the claims.

I/we claim:

1. A method for determining function time consumption, comprising:
obtaining function time consumption stacks reported by a client for a target scenario, wherein the function time consumption stacks comprise function call information and original time consumption information of at least part of functions in the target scenario;
splitting each of the function time consumption stacks into a plurality of sub-stacks based on scenario stages of the target scenario; and
aggregating the sub-stacks to obtain target time consumption information of the at least part of functions.

2. The method of claim 1, wherein the function time consumption stacks further comprise a marker function, and wherein the marker function being used for indicating at least one of a starting time and an ending time of a scenario stage corresponding to the marker function.

3. The method of claim 2, wherein splitting each of the function time consumption stacks into a plurality of sub-stacks based on scenario stages of the target scenario comprises:
for each function time consumption stack, identifying a marker function in the function time consumption stack;
determining stage starting and ending time for each scenario stage in the target scenario based on the marker function, and wherein the stage starting and ending time comprises a starting time and an ending time;
splitting the function time consumption stack into a plurality of sub-stacks based on the stage starting and ending time.

4. The method of claim 3, wherein determining the stage starting and ending time for each scenario stage in the target scenario based on the marker function comprises:
for each scenario stage, obtaining original starting and ending time indicated by a marker function corresponding to a current scenario stage;
in response to the current scenario stage calling one thread, using the original starting and ending time as stage starting and ending time of the current scenario stage;
in response to that the current scenario stage calling a plurality of threads, performing stage mapping on each target thread based on the original starting and ending time to obtain a new scenario stage on each target thread, and obtaining stage starting and ending time of the new scenario stage, wherein the target thread is a thread being called at the current scenario stage.

5. The method of claim 4, wherein performing stage mapping on each target thread based on the original starting and ending time to obtain a new scenario stage on each target thread comprises:
for each target thread, performing stage mapping on the current scenario stage on the target thread based on the original starting and ending time, so as to obtain a mapping stage on the target thread;
in response to the mapping stage overlapping with a non-mapping stage on the target thread, obtaining a stage segment of the mapping stage which does not overlap with the non-mapping stage as a new scenario stage on the target thread; and
in response to the mapping stage not overlapping with a non-mapping stage on the target thread, using the mapping stage as a new scenario stage on the target thread.

6. The method of claim 3, wherein prior to splitting the function time consumption stack into a plurality of sub-stacks based on the stage starting and ending times, the method further comprises at least one of:
for a target function starting and ending at different scenario stages, splitting the target function based on stage starting and ending time of a target scenario stage to obtain a new function corresponding to each target scenario stage, wherein the target scenario stage is at least one of a scenario stage starting and a scenario stage ending in the running process of the target function;
determining processor starting and ending time of each scenario stage based on processor time consumption information of each scenario stage; and
verifying stage information of each scenario stage and marking the stage information which is verified as anomaly, wherein the stage information comprises at least one of a stage order and a count of marking of the marker function.

7. The method of claim 1, wherein aggregating the sub-stacks to obtain target time consumption information of the at least part of functions comprises:
generating an original function call tree corresponding to each sub-stack;
merging the original function call trees to obtain a target function call tree of the target scenario; and
determining the target time consumption information of the at least part of functions based on the target function call tree.

8. The method of claim 7, wherein merging the original function call trees to obtain the target function call tree of the target scenario comprises:
for each scenario stage of each thread, merging original function call trees corresponding to the scenario stage at the function time consumption stacks to obtain a first function call tree corresponding to the scenario stage;
for each thread, merging the first function call trees corresponding to different scenario stages in the thread to obtain a second function call tree corresponding to the thread; and
merging the second function call trees corresponding to different threads to obtain the target function call tree of the target scenario.

9. The method of claim 8, wherein merging original function call trees corresponding to the scenario stage at the function time consumption stacks to obtain the first function call tree corresponding to the scenario stage comprises:
merging original function call trees corresponding to the scenario stage in each function time consumption stack respectively, so as to obtain a third function call tree corresponding to the scenario stage in each function time consumption stack; and
merging the third function call trees corresponding to the scenario stage in different function time consumption stacks to obtain the first function call tree corresponding to the scenario stage.

10. The method of claim 8, wherein threads with the same thread identifier are the same thread, and prior to aggregating the sub-stacks, the method further comprises:
adjusting a thread identifier of a thread called in the target scenario.

11. The method of claim 10, wherein adjusting the thread identifier of the thread called in the target scenario comprises at least one of:
adjusting a thread identifier of a first thread in the target scenario as a first preset thread identifier, wherein the first thread is a main thread;
adjusting a thread identifier of a second thread in the target scenario as a thread identifier associated with the second thread, wherein the second thread is a sub thread called at a scenario stage of the target scenario; and
adjusting a thread identifier of a third thread in the target scenario as a second preset thread identifier, wherein the third thread is a sub thread other than the second thread in the target scenario.

12. The method of claim 7, wherein determining the target time consumption information of the at least part of functions based on the target function call tree comprises:
generating a function time consumption file of the target scenario based on the target function call tree, the function time consumption file being a visualization file, wherein the visualization file is used for presenting target time consumption information of each function in the at least part of functions.

13. The method of claim 7, wherein prior to determining the target time consumption information of the at least part of functions based on the target function call tree, the method further comprises:
pruning a function node in the target function call tree in which parameter value is a default value.

14. An electronic device, comprising:
at least one processor;
a memory communicatively connected with the at least one processor; wherein the memory stores computer executable instructions executable by the at least one processor, the computer executable instructions, when executed by the at least one processor, cause the at least one processor to:
obtain function time consumption stacks reported by a client for a target scenario, wherein the function time consumption stacks comprise function call information and original time consumption information of at least part of functions in the target scenario;
split each of the function time consumption stacks into a plurality of sub-stacks based on scenario stages of the target scenario; and
aggregate the sub-stacks to obtain target time consumption information of the at least part of functions.

15. The electronic device of claim 14, wherein the function time consumption stacks further comprise a marker function, and wherein the marker function being used for indicating at least one of a starting time and an ending time of a scenario stage corresponding to the marker function.

16. The electronic device of claim 15, wherein the computer executable instructions to split each of the function time consumption stacks into a plurality of sub-stacks based on scenario stages of the target scenario comprise computer executable instructions to:
for each function time consumption stack, identify a marker function in the function time consumption stack;
determine stage starting and ending time for each scenario stage in the target scenario based on the marker function, and wherein the stage starting and ending time comprises a starting time and an ending time;
split the function time consumption stack into a plurality of sub-stacks based on the stage starting and ending time.

17. The electronic device of claim 16, wherein the computer executable instructions to determine the stage starting and ending time for each scenario stage in the target scenario based on the marker function comprise computer executable instructions to:
for each scenario stage, obtain original starting and ending time indicated by a marker function corresponding to a current scenario stage;
in response to the current scenario stage calling one thread, use the original starting and ending time as stage starting and ending time of the current scenario stage;
in response to that the current scenario stage calling a plurality of threads, perform stage mapping on each target thread based on the original starting and ending time to obtain a new scenario stage on each target thread, and obtain stage starting and ending time of the new scenario stage, wherein the target thread is a thread being called at the current scenario stage.

18. The electronic device of claim 17, wherein the computer executable instructions to perform stage mapping on each target thread based on the original starting and ending time to obtain a new scenario stage on each target thread comprise computer executable instructions to:
for each target thread, perform stage mapping on the current scenario stage on the target thread based on the original starting and ending time, so as to obtain a mapping stage on the target thread;
in response to the mapping stage overlapping with a non-mapping stage on the target thread, obtain a stage segment of the mapping stage which does not overlap with the non-mapping stage as a new scenario stage on the target thread; and
in response to the mapping stage not overlapping with a non-mapping stage on the target thread, use the mapping stage as a new scenario stage on the target thread.

19. The electronic device of claim 16, wherein prior to the computer executable instructions to split the function time consumption stack into a plurality of sub-stacks based on the stage starting and ending times, the method further comprises at least one of computer executable instructions to:
for a target function starting and ending at different scenario stages, split the target function based on stage starting and ending time of a target scenario stage to obtain a new function corresponding to each target scenario stage, wherein the target scenario stage is at least one of a scenario stage starting and a scenario stage ending in the running process of the target function;
determine processor starting and ending time of each scenario stage based on processor time consumption information of each scenario stage; and
verify stage information of each scenario stage and marking the stage information which is verified as anomaly, wherein the stage information comprises at least one of a stage order and a count of marking of the marker function.

20. A non-transitory computer readable storage medium, wherein the computer readable storage medium stores computer executable instructions which, when executed by a processor, cause the processor to:
obtain function time consumption stacks reported by a client for a target scenario, wherein the function time consumption stacks comprise function call information and original time consumption information of at least part of functions in the target scenario;
split each of the function time consumption stacks into a plurality of sub-stacks based on scenario stages of the target scenario; and
aggregate the sub-stacks to obtain target time consumption information of the at least part of functions.
